(19) United States
(12) Patent Application Publication
(10) Pub. No.: US 2007/0270110 A1
(43) Pub. Date: Nov. 22, 2007

(54) Analog front end for a wireless device

(75) Inventors: Sergey Smirnov, Ekaterinburg (RU); Alexander Rapoport, Ekaterinburg (RU)

Correspondence Address: DARBY & DARBY P.C., P.O. BOX 770, Church Street Station, New York, NY, 10008-0770, US

(73) Assignee: InfiNet Wireless Limited, Tortola (VG)

(21) Appl. No.: 11/437,263

(22) Filed: May 18, 2006

(51) Int. Cl. H04B 1/04; H01Q 11/12

(52) U.S. Cl. 455/127.1; 455/114.3; 455/129

(57) ABSTRACT

A novel amplifier for a wireless device is disclosed. The system employing the preferred embodiment can deliver a radio signal with output power up to 500 mW for 64QAM (48 Mb/s bit rate) modulation and a radio signal up to 700 mW for 16QAM (36 Mb/s bit rate) modulation with the packet error rate below 1%. The increase of the signal from 10 to 500 mW (64QAM modulation) thus increases the base station coverage area 50 times.

### BACKGROUND OF THE INVENTION

BWA (Broadband Wireless Access) systems provide MAN (Metropolitan Area Network) broadband connectivity access. Such systems can be used to transmit signals as far as 30 miles. These systems use 16-65 QAM (quadruture amplitude modulation) and OFDM (orthogonal frequency division multiplexing) encoding algorithms.

There are a number of wireless devices used to provide broadband wireless access (wireless access point, wireless customer premises equipment, wireless devices for point-to-point connectivity, wireless switches and wireless routers). While providing different functionality they all need powerful, distortion-free amplifiers.

For example, a wireless access point is a wireless device that hooks into an existing network that receives signals from other wireless devices and transmits signals to other wireless devices to gain access to a network or to go out onto the Internet. It may also act as a bridge to extend the range of a wireless network. A wireless access point may also be a device that connects wireless communication devices together to create a wireless network. A wireless access point may be connected to a wired network, and can relay data between devices on each side. Many wireless access points can be connected together to create a larger network that allows “roaming”.

There are many technical demands on the access points that support modern wireless standards and implement modern encoding algorithms. For example, it is desirable for such wireless access points to output signals having sufficiently high power to provide reliable wireless access over significant distances, while minimizing errors and heat-dissipation related problems. In addition, in order to achieve a broad market penetration these systems have to satisfy significant cost and size limitations as known in the art.

For a successful wireless access point operation supporting modern standards, such as mentioned above, it is desirable to achieve linear amplification of the output signal. Consequently, the design of the amplification electronics should be adjusted to deal with interferences that, for example, may be caused by the resonance induced by various elements in the amplification circuitry.

Typically, performance vs. cost design trade-offs used to reduce interferences and improve linearity cause a reduction in output power. When operating within the linear region of the component, gain through the component is constant for a given frequency. As the input signal is increased in power, a point is reached where the amount of amplification of the signal at the output is not the same as for a smaller signal. At the point where the input signal is amplified by an amount 1 dB less than the small signal gain, the 1 dB Compression Point (P1dB) has been reached. In a typical system satisfying the linearity requirements associated with IEEE 802.11a/g or IEEE802.16d standards, the output power is about 6 dB lower than the P1dB threshold under standard operating conditions. A typical front end amplifier for a wireless access point, based on the circuits with P1dB in the 26-30 dBm range, achieves for 64 OFDM and 64 QAM, the peak output power of 20-24 dBm. Employing more powerful amplifying circuits and using discrete components in the output circuitry would further increase the cost of the system and complicate the heat dissipation problems, particularly, when dealing with frequencies above the 1 GHz range.

A typical example of a circuit that transmits and receives signals from the antenna of a wireless access point is illustrated in FIG. 1 (prior art). Signal 101 controls whether, at a given instant in time, the circuitry is in the receive or transmit mode. In the transmit mode, the signal is provided from the analog output access point circuitry 102 to the amplifier 104. The output signal is then amplified at 104 and provided through the switching element 105, which is controlled by signal 101, to the antenna 106. In this mode, no signal is received. In the receive mode, the signal is detected at antenna 106 and then provided through switching elements 105 to the input access point circuits 103.

It is desirable to provide a solution that provides lower distortions and better amplification than the described above design, without a substantial increase in cost of the amplification circuit.

### SUMMARY

A broadband wireless apparatus operating in the 1-6 GHz range, which provides wireless connection to a computer network, is disclosed. It includes an antenna interfaced to a power amplifier circuit block, which provides received analog signals for processing and amplifies an output analog signal for transmission. The amplifier circuit block includes dividing circuitry, which preferably is a microstrip splitter, that divides the output analog signal into first and second substantially identical in-phase signals. The block further includes a first amplifier having an input connected to the dividing circuitry, which receives the first in-phase signal and a second amplifier having an input connected to the dividing circuitry, which receives the second in-phase signal, wherein the first and the second amplifiers each provide an amplification essentially equal to one half of a desired amplification, so as to produce, respectively, first and second half-amplified signals. In addition the amplifier circuit block includes an adder circuit having a first input connected to output of the first amplifier and a second input connected to output of the second amplifier, which adds the first and the second half-amplified signals so as to produce an amplified output signal having essentially the desired amplification and a distortion level comparable with distortion of a signal amplified to one half of the desired amplification. The adder circuit preferably includes a strip line transformer. A circulator is electrically connected to the adder circuit for providing the amplified output signal to the antenna.

The above circuit block preferably includes a control line connected to the first and the second amplifiers so as to turn off the amplifiers when the apparatus is in the mode of receiving the received analog signal. Preferably, both amplifiers mentioned above have the P1dB point essentially in the 26-30 dBm range. Preferably, the desired amplification of this circuit block is substantially 30 dB. It provides the amplified output signal is in the range of 200-500 mW for 64QAM modulation with packet error rate below 1%. Also, the amplified output signal is in the range of 400-700 mW for 16 QAM modulation with packet error rate below 1%.

The following disclosure also includes a method of amplifying a signal for transmission by a broadband wireless device, operating in the 1-6 GHz range, that receives signals from one or more wireless devices and transmits signals to one or more wireless devices so as to enable communication in a computer network. According to this method, the signal is divided into first and second signals. The first and the second signals are amplified with two substantially identical first and second amplifiers, respectively, which output respectively amplified first and amplified second signals, which have essentially the same frequency for useful signal and essentially different frequencies of amplitude-frequency distortions. The amplified first and amplified second signals are added so as to obtain a resultant signal, having an amplitude equal essentially to the sum of the amplitudes of the amplified first and amplified second signals, and having an amplitude of the frequency-response curve distortion which is essentially not increased relative to amplification of either the first and second signals individually. The resultant signal is provided to a circulator operationally connected to an antenna. The first and the second amplifiers are disabled when the circulator is in the receiving mode.

In this method, preferably, the P1dB point of each of the amplifiers is essentially in the 26-30 dBm range. The resultant signal is preferably in the range of 200-500 mW for 64QAM modulation with packet error rate below 1%.

The following disclosure also includes, a method of amplifying a signal for transmission by a broadband wireless device, operating in a 1-6 GHz range, functions as follows. In general, the device receives signals from one or more wireless devices and transmits signals to one or more wireless devices so as to enable communication in a computer network. The signal is divided into a plurality of signals. The plurality of signals are amplified with a plurality of respective amplifiers which output respectively a plurality of amplified signals, which have essentially different frequencies of frequency-response distortions. The amplified plurality of signals are added so as to obtain a resultant signal having amplitude equal essentially to the sum of amplitudes of the amplified plurality of signals, and having frequency-response distortions essentially comparable to the distortion of each of the individual amplified plurality of signals. The resultant signal is provided to an antenna. As part of this method, the resultant signal is provide to a circulator operationally connected to an antenna. All amplifiers are disabled when the apparatus is in the mode of receiving the received analog signal. The P1dB point of each of the amplifiers preferably is essentially in the 26-30 dBm range.

### BRIEF DESCRIPTION OF THE DRAWINGS

FIG. 1 is a block diagram of the amplification receive/transmit output circuitry of a prior art wireless access point.

FIG. 2 is a block diagram of the overall wireless access point architecture in accordance with an embodiment of the present invention.

FIG. 3 is a block diagram of the preferred amplification circuitry of the preferred wireless access point in accordance with an embodiment of the present invention.

FIG. 4 is a schematic illustration of the preferred amplification circuitry of the preferred wireless access point in accordance with an embodiment of the present invention.

FIG. 5 is a graph illustrating the frequency-response curve of the preferred amplification circuitry in accordance with an embodiment of the present invention.

### DETAILED DESCRIPTION OF THE PREFERRED EMBODIMENTS

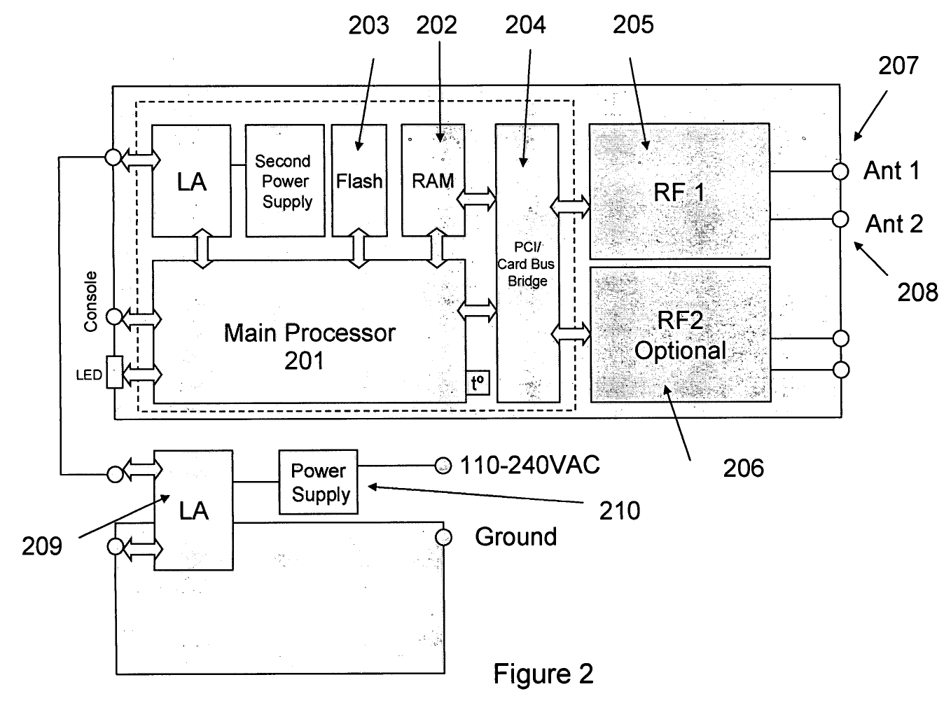

An example of a wireless access point architecture is illustrated in FIG. 2. It includes main processor 201, which performs the primary access point computational operations as known in the art. Processor 201 interfaces to RAM memory 202 and Flash Memory 203 as well as to the PCI system bus 204 which in turn is connected to modules RF1 205 and optionally RF2 206, which convert digital output to analog form and analog input signals to digital form. Modules 205 and 206 are interfaced through amplification circuitry to one or more antennas, such as 207 and 208. Element 209 LA (Lighting Arrester) protects the equipment on both sides of the connected cables (e.g., the Ethernet and power cables) from electromagnetic spikes occurring during lightning and other electromagnetic events. Power Supply 210 transforms the input voltage from 110 or 220V to 24 or 48V. Elements illustrated in FIG. 2 and how to interface them, as illustrated, are generally known in the art.

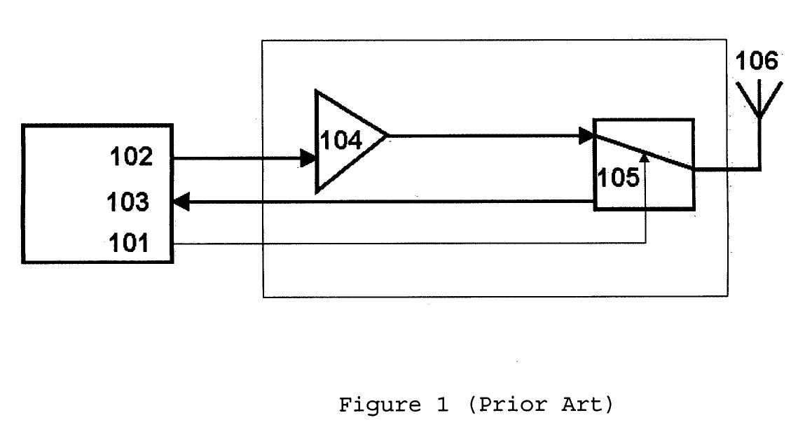

The amplification circuits are located between the input/output analog modules RF1 and RF2 and the corresponding antennas. In the prior art, wireless devices employed the amplification circuitry as illustrated in FIG. 1. As noted, such circuitry has various drawbacks that preclude high power amplification.

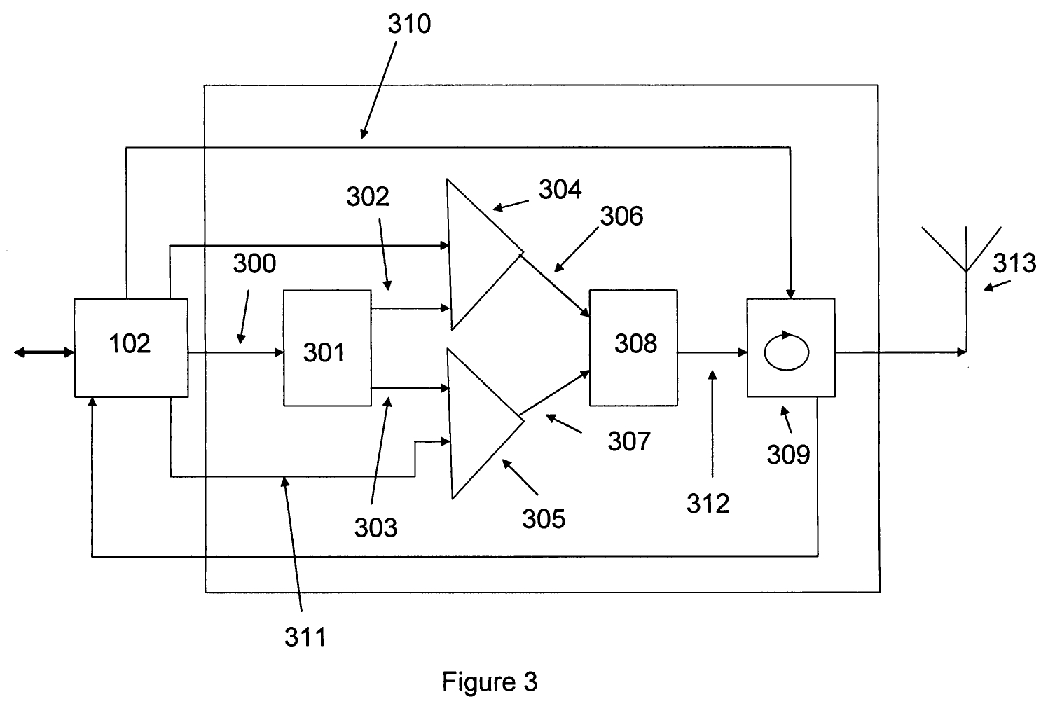

In the preferred embodiment, the wireless device employs a power amplifier block implemented on a multilayer printed circuit board designed as illustrated in FIG. 3. An in-phase bridge 301 implemented as a microstrip splitter divides the output analog signal 300 into two in-phase components, 302 and 303. Signal 302 is provided to amplifiers 304 and signal 303 is provided to amplifiers 305. These two amplifiers, provided as microstrip amplifiers, are substantially identical except for minor variations in their amplitude/frequency characteristics. Each of the amplifiers 304 and 305 provides preferably one half of the desired signal amplification. Notably, the minor differences between the amplifiers are simply due to the differences in the amplifier chip characteristics and frequency characteristics of the PCB circuits.

An in-phase bridge 308 implemented as a microstrip transformer combines amplified signals 306 and 307 outputted by the amplifiers 304 and 305. All the above mentioned elements are known in the art. As a result, power of the output signal can be doubled, while keeping the level of distortion substantially equal to the level of the frequency-response curve distortions of a single amplifier.

The combined signal 312 obtained after the in-phase bridge 308 is input into the circulator 309. In the receiving mode, the amplifiers 304 and 305 are turned off by the signal 311. As known, the circulator 308 provides signals to and from the antenna 309. The use of the circulator, as opposed to the use of high speed switching elements in the prior art embodiment of FIG. 1 further reduces switching delay problems. In addition, the circulator does not dampen down the signal in the amplification path as much (only by, for example, 0.5 dB) as compared to a typical switching element (0.8-1.2 dB). It is known that the loss of 0.5 dB in the amplification path is essentially equivalent to the reduction of the output power from 500 to 440 mW. Thus, the use of the circulator further increases the efficiency of the preferred amplifier block. Furthermore, a typical switching element imposes limitations on the linear portion of the frequency-response curve, which is also characterized by the P1dB point. For currently widely-used switching elements this power is in the 30 dBm range. Consequently, the use of switching elements in amplifiers with power exceeding 24 dBm for the 64 QAM & 64 OFDM signals is likely to cause distortions at the output.

It should be noted that the preferred design provides economic advantages, for example, for producing power outputs in the 500 mW range, because the price of an amplifier chip with P1dB=30 dBm typically does not exceed $10, which is approximately ten times less than the cost of amplifier chips with P1dB=36 dBm.

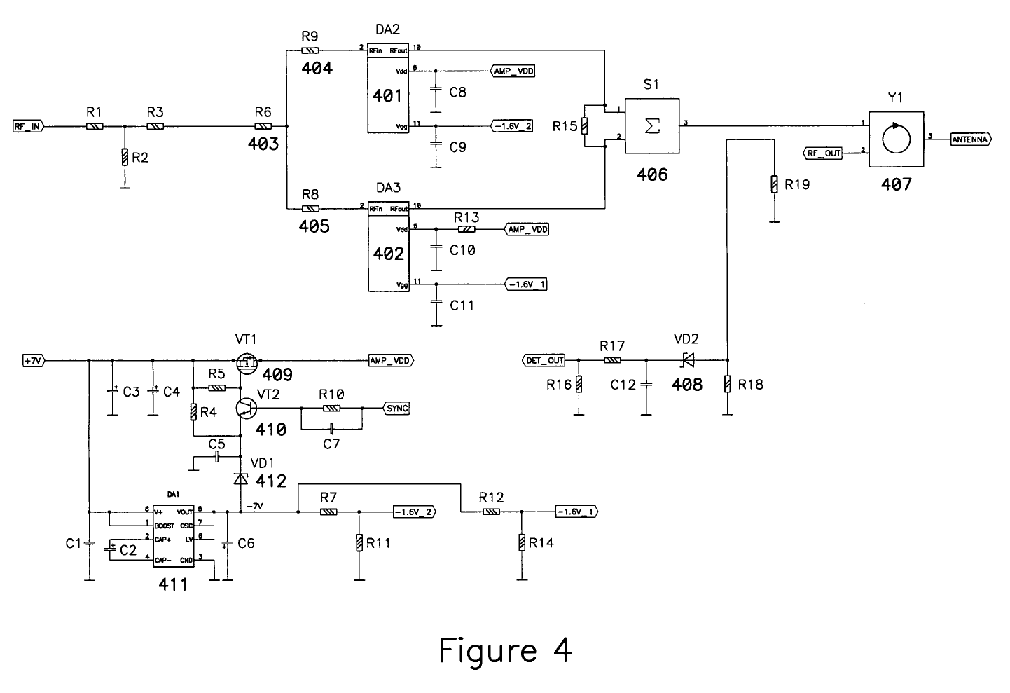

A circuit diagram of the power amplifier block is illustrated in FIG. 4 (the diagram also includes the output power calibration circuitry and secondary power supply circuitry).

The output signal is provided to the inputs of the amplifier circuits 401 (DA2) and 402 (DA3) through the microstrip splitter formed on the printed circuit board by interconnecting the resistors 403, 404 and 405 (R6, R9, R8). The amplified signals are then added at the microstrip adder 406 (S1) and provided to the circulator 407 (Y1). The input signal detected by the antenna is provided from the circulator 407 directly to the input circuitry of the access point (not shown on FIG. 4).

In the path between the microstrip adder 406 and the circulator 407 a part of the power of the amplified signal branches out by means of a microstrip coupler (illustrated as circuitry in the right lower part of the schematics of FIG. 4) and it is provided to the peak detector assembled using diode 408 (VD2). This signal is then used in the wireless device for detecting the current output power of the output signal.

The power switch assembled using transistors 409 and 410 (VT1 and VT2) switches on the power to the amplifiers during transmission. A secondary power supply assembled using a microchip 411 (DA1), supplies a negative voltage offset for the amplifiers 401 and 402. A diode 412 (VD1) prevents supplying the power without a negative voltage offset.

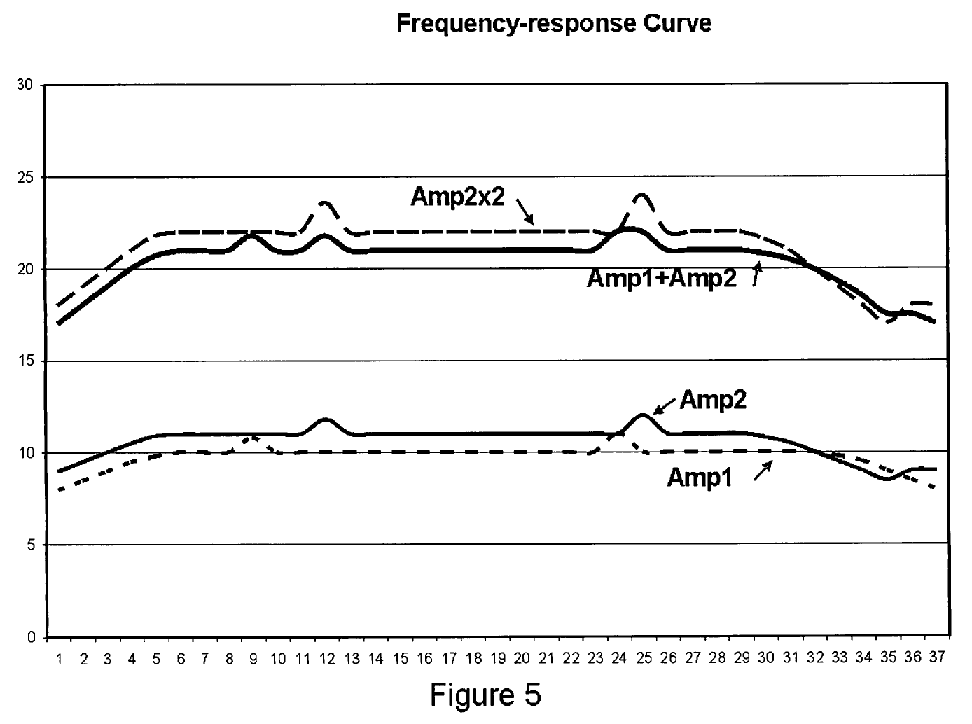

FIG. 5 further illustrates the advantages of the preferred design. Plots 501 and 502 illustrate the spectral characteristics of the output signal of amplifiers 305 and 306. Both of these plots have disturbances shown as 503-506. When these two signals are added, the combined one, 507, is generated. While signal 507 also contains some distortions such as 508-510, the level of amplitude-frequency distortion is rather moderate, particularly when contrasted with the one at the output of a single amplifier with twice the amplification of amplifiers 305 and 306.

As noted above, in the system of the preferred embodiment, higher output power can be achieved with an acceptable level of amplitude-frequency distortion. It should also be noted that due to a distributed design of the preferred power amplifier block (the heat dissipation elements are separated from each other), the heat dissipation is improved, so that the heat issue can be effectively dealt with even when the power and speed are significantly increased.

In a wireless access point working in the 1-6 GHz range, as used in modern wireless communications, the amplitude-frequency distortion in the preferred embodiment can be decreased by about 3 dB and the power is doubled in comparison to a single elementary amplifier. The system employing the preferred embodiment can deliver the radio signal with the average maximum output power up to 500 mW for 64 QAM (48 Mb/s bit rate) modulation with a packet error rate below 1%. The increase of the signal from 10 to 500 mW (64 QAM modulation) leads to an increase in the base station coverage area of 50 times.

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims. Doubtless numerous other embodiments can be conceived that would not depart from the teaching of the present invention whose scope is defined by the following claims.

1. A broadband wireless apparatus operating in the 1-6 GHz range, which provides wireless connection to a computer network, comprising:
an antenna interfaced to a power amplifier circuit block, which provides received analog signals for processing and amplifies an output analog signal for transmission, said amplifier circuit block comprising:
dividing circuitry that divides the output analog signal into first and second substantially identical in-phase signals;
a first amplifier having an input connected to the dividing circuitry, which receives the first in-phase signal and a second amplifier having an input connected to the dividing circuitry, which receives the second in-phase signal, wherein the first and the second amplifiers each provide an amplification essentially equal to one half of a desired amplification, so as to produce, respectively, first and second half-amplified signals;
an adder circuit having a first input connected to output of the first amplifier and a second input connected to output of the second amplifier, which adds the first and the second half-amplified signals so as to produce an amplified output signal having essentially the desired amplification and a distortion level comparable with distortion of a signal amplified to one half of the desired amplification; and
a circulator electrically connected to the adder circuit for providing the amplified output signal to the antenna.

2. The apparatus of claim 1, wherein said adder circuit comprise a strip line transformer.

3. The apparatus of claim 1, further comprising a control line connected to the first and the second amplifiers so as to turn off said amplifiers when the apparatus is in the mode of receiving the received analog signal.

4. The apparatus of claim 1, wherein both amplifiers have the P1dB point essentially in the 26-30 dBm range.

5. The apparatus of claim 1, wherein the desired amplification is substantially 30 dB.

6. The apparatus of claim 1, wherein the amplified output signal is in the range of 200-500 mW for 64 QAM modulation with packet error rate below 1%.

7. The apparatus of claim 1, wherein the amplified output signal is in the range of 400-700 mW for 16 QAM modulation with packet error rate below 1%.

8. The apparatus of claim 1, wherein the dividing circuitry is a microstrip splitter.

9. A method of amplifying a signal for transmission by a broadband wireless device, operating in the 1-6 GHz range, that receives signals from one or more wireless devices and transmits signals to one or more wireless devices so as to enable communication in a computer network comprising the following steps:
dividing said signal into first and second signals;
amplifying said first and said second signals with two substantially identical first and second amplifiers, respectively, which output respectively amplified first and amplified second signals, which have essentially the same frequency for useful signal and essentially different frequencies of amplitude-frequency distortions;
adding said amplified first and amplified second signals so as to obtain a resultant signal, having an amplitude equal essentially to the sum of the amplitudes of the amplified first and amplified second signals, and having an amplitude of the frequency-response curve distortion which is essentially not increased relative to amplification of either said first and second signals individually; and
providing said resultant signal to a circulator operationally connected to an antenna.

10. The method of claim 9, wherein the P1dB point of each of the amplifiers is essentially in the 26-30 dBm range.

11. The method of claim 9, further comprising the step of disabling the first and the second amplifiers when the circulator is in the receiving mode.

12. The method of claim 9, wherein the resultant signal is in the range of 200-500 mW for 64 QAM modulation with packet error rate below 1%.

13. A method of amplifying a signal for transmission by a broadband wireless device, operating in a 1-6 GHz range, that receives signals from one or more wireless devices and transmits signals to one or more wireless devices so as to enable communication in a computer network, comprising:
dividing said signal into a plurality of signals;
amplifying said plurality signals with a plurality of respective amplifiers which output respectively a plurality of amplified signals, which have essentially different frequencies of frequency-response distortions; and
adding said amplified plurality of signals so as to obtain a resultant signal having amplitude equal essentially to the sum of amplitudes of the amplified plurality of signals, and having frequency-response distortions essentially comparable to the distortion of each of the individual amplified plurality of signals; and
providing said resultant signal to an antenna.

14. The method of claim 13 further comprising the step of providing said resultant signal to a circulator operationally connected to an antenna.

15. The method of claim 13, wherein the P1dB point of each of the amplifiers is essentially 26-30 dBm range.

16. The method of claim 13, further comprising the step of disabling all amplifiers when the apparatus is in the mode of receiving the received analog signal.
